(19) United States
(12) Patent Application Publication
(10) Pub. No.: US 2017/0121455 A1
(43) Pub. Date: May 4, 2017

(54) Liquid Titanium-Based Catalyst And Method For Preparing Polyester Polymer Thereof

(71) Applicant: Anqing Hexing Chemical., Ltd., Anhui (CN)

(72) Inventors: Shijin MA, Anhui (CN); Yuegang BAO, Anhui (CN); Yun MA, Anhui (CN); Ling ZHANG, Anhui (CN); Yuxiu QIAN, Anhui (CN)

(73) Assignee: Anqing Hexing Chemical., Ltd., Auhui (CN)

(21) Appl. No.: 15/311,522

(22) PCT Filed: Jun. 10, 2015
(86) PCT No.: PCT/CN2015/081115

§ 371 Date: Nov. 16, 2016

(30) Foreign Application Priority Data
Apr. 28, 2015 (CN) 2015 102093132

(51) Int. Cl. C08G 63/85; C08J 3/12; C08G 63/16

(52) U.S. Cl. CPC C08G 63/85; C08G 63/16; C08J 3/12; C08J 2367/02

(57) ABSTRACT

A liquid titanium-based catalyst and method for preparing polyester polymer thereof are disclosed herein. The catalyst is made by tetrabutyl titanate, 1-4 butanediol, phosphate ester, hydroxycarboxylic acid, TEOS, acetates of metal element through heating reactions in an appropriate amount of solvent. While the catalyst maintains a high activity, the synthetic slices have good hue, with high molecular weight, stable property, resistance to hydrolysis, moreover, the catalyst is a stable multicomponent liquid catalyst based on titanium, silicon. It can be directly added or diluted to add to the raw material ester or oligoester to be poly-condensed used for synthesis of polyesters which can be used in the production of fibers, engineering plastics, films, PET bottles, sheets and profiles, etc.

### BACKGROUND OF THE INVENTION

The present invention relates to the field of chemical technology, in particular, to a liquid titanium-based catalyst and method for preparing polyester polymer thereof.

Generally, traditional polyester polymers mainly use antimony, germanium, titanium compounds; however, antimony may be reduced to separate out that makes color variation and produces water pollution; while the germanium has a high cost, and titanium compound itself is unstable, resulting in unstable performance of polyester polymers and poor quality of polyester polymer products. Under such circumstance, we have to develop a new kind of polyester catalyst which is easy to dissolve stable, homogeneous and effective catalyst components, to facilitate to add polyester reaction system, besides, the catalyst should have good catalytic activity, with less impurity groups, and the synthetic polyester products have good hue, especially they are stable and economical.

### BRIEF SUMMARY OF THE INVENTION

The object of the present invention is to provide a liquid titanium-based catalyst and the method for preparing polyester polymers thereof, to solve the problems in the prior art such as excessively high cost of traditional catalysts used for producing polyester polymer, or unstable performance of catalysts, which cause incapable of producing polyester polymers.

To achieve the above object, the present invention employs the following technical solutions:

A liquid titanium-based catalyst comprising the following compositions (in mass ratio):

1,4 butanediol 450-900 portions

TEOS and/or n-methyl silicate and/or n-propyl silicate 10.4-41.6 portions

Acetates or aluminum nitrate 10.7-42.8 portions

Tetrabutyl titanate and/or tetraethyl titanate and/or tetraisopropyl titanate 228-340 portions

Solvent 92-2700 portions

Hydroxycarboxylic acid 15-150 portions

Phosphate ester 273-546 portions

Further, the solvents are one or more of anhydrous ethanol, cyclohexane, toluene, mixed xylene.

Further, the acetates are selected from one or more of acetates of IA, IIA, IIIA, IIB, IIIB, VIIB, VIIIB metal elements.

Further, the hydroxycarboxylic acids are one or more of citric acid, L-lactic acid, tartaric acid, salicylic acid.

Further, the phosphate esters are one or more of trimethyl phosphate, triethyl phosphate, trimethyl phosphite, triethyl phosphite, triphenyl phosphate.

Further, a method for preparing liquid titanium-based catalyst, comprising the following steps:

a) adding 1,4-butanediol, TEOS and/or n-methyl silicate and/or n-propyl silicate, acetates or aluminum nitrate, tetrabutyl titanate and/or tetraethyl titanate and/or tetraisopropyl titanate to a three-necked glass flask with a stirrer, dissolved in the solvent, and reacting 0.5˜3 h at the temperature of 80˜200° C.;

b) then adding hydroxycarboxylic acid, phosphate ester to continue to react 0.5˜3 h at the temperature of 80˜200° C., to obtain titanium-containing liquid catalyst.

Further, liquid titanium-based catalyst is used for preparing polyester polymer.

Further, the application of liquid titanium-based catalyst in polyester polymer, comprising the following steps:

1) adding 100 portions of succinic acid, 95-109 portions of 1-4 butanediol, 10-20 portions of adipic acid, to a reactor, to have an esterification reaction under the normal pressure condition for 2-5 h to get the material;

2) then conveying the material to a polymerization reactor with nitrogen gas, adding 2 portions of diluted liquid titanium-based catalyst to stir 10 min, and gradually heating the reactor to increase the temperature of reactants and start the vacuum pump to gradually reduce the vacuum degree in the reactor for polymerization reaction, then reducing the vacuum degree to 1 mmHg or less, and increasing the temperature to 240˜260° C., 3-8 hours later, stopping the reaction;

3) discharging the material in the reactor by pressurizing with nitrogen gas, and cooling down the polymer, granulating by a granulator to get the polyester granules.

The present invention can achieve the following advantages: while the catalyst maintains a high activity, the synthetic slices have good hue, with high molecular weight, stable property, resistance to hydrolysis, moreover, the catalyst is a stable multicomponent liquid catalyst based on titanium, silicon. It can be directly added or diluted to add to the raw material ester or oligoester to be poly-condensed used for synthesis of polyesters which can be used in the production of fibers, engineering plastics, films, PET bottles, sheets and profiles, etc.

### BRIEF DESCRIPTION OF THE DRAWINGS

FIG. 1 is the first waveform schematic drawing of the elongation at break and the tensile strength in the embodiment of different tensile test:

FIG. 2 is the second waveform schematic drawing of the elongation at break and the tensile strength in the embodiment of different tensile test: and

FIG. 3 is the third waveform schematic drawing of the elongation at break and the tensile strength in the embodiment of different tensile test.

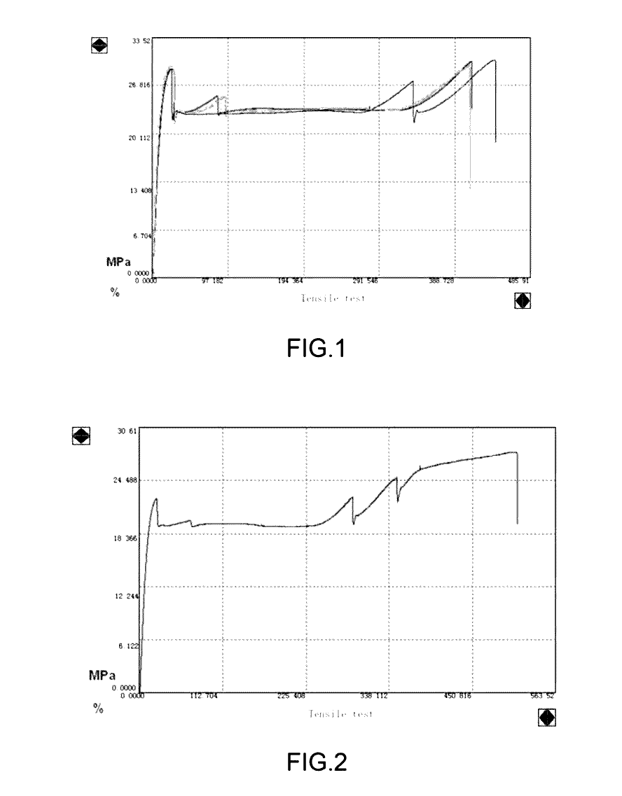

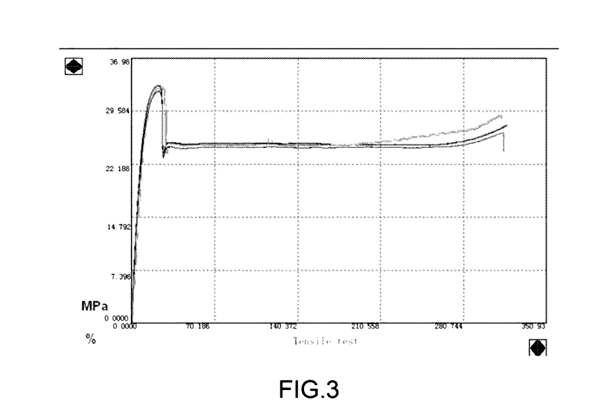

### DETAILED DESCRIPTION OF THE INVENTION

### Embodiment 1 Preparation of Liquid Titanium-Based Catalyst

450 g 1, 4-butanediol, 10.4 g TEOS, 10.7 g magnesium acetate, 228 g tetrabutyl titanate were added to a three-necked glass flask with a stirrer, dissolved in 92 g anhydrous ethanol solution, to react 0.5 hour under 80° C. to remove some small molecules; at this time, 15 g tartaric acid, 273 g triethyl phosphate were added successively to continue to react 0.5 h under 80° C., then the byproduct was removed, to get liquid catalyst containing 4.20 wt % titanium.

### Embodiment 2 Preparation of Liquid Titanium-Based Catalyst

506.2 g 1, 4-butanediol, 14.3 g TEOS, 14.7 g manganese acetate, 228 g tetrabutyl titanate were added to a three-necked glass flask with a stirrer, dissolved in 150 g anhydrous ethanol solution, to react 0.8 hour under 100° C. to remove some small molecules; at this time, 31.3 g citric acid, 307.1 g triethyl phosphate were added successively to continue to react 0.8 h under 100° C., then the byproduct was removed, to get liquid catalyst containing 4.25 wt % titanium.

### Embodiment 3 Preparation of Liquid Titanium-Based Catalyst

562.5 g 1, 4-butanediol, 18.2 g TEOS, 18.7 g magnesium acetate, 256 g tetrabutyl titanate were added to a three-necked glass flask with a stirrer, dissolved in 400 g anhydrous ethanol solution, to react 1 hour under 110° C. to remove some small molecules; at this time, 48.7 g citric acid, 341.2 g triethyl phosphate were added successively to continue to react 1 hour under 110° C., then the byproduct was removed, to get liquid catalyst containing 4.19 wt % titanium.

### Embodiment 4 Preparation of Liquid Titanium-Based Catalyst

618.7 g 1, 4-butanediol, 22.1 g TEOS, 22.7 g manganese acetate, 270 g tetrabutyl titanate were added to a three-necked glass flask with a stirrer, dissolved in 800 g anhydrous ethanol solution, to react 1.4 hour under 120° C. to remove some small molecules; at this time, 65.1 g tartaric acid, 425.3 g triethyl phosphate were added successively to continue to react 1.4 hour under 120° C., then the byproduct was removed, to get liquid catalyst containing 4.23 wt % titanium.

### Embodiment 5 Preparation of Liquid Titanium-Based Catalyst

675 g 1, 4-butanediol, 26 g TEOS, 26.7 g aluminum nitrate, 284 g tetrabutyl titanate were added to a three-necked glass flask with a stirrer, dissolved in 1,300 g anhydrous ethanol solution, to react 1.6 hour under 150° C. to remove some small molecules; at this time, 82.5 g citric acid, 409.5 g triethyl phosphate were added successively to continue to react 1.6 hour under 150° C., then the byproduct was removed, to get liquid catalyst containing 4.18 wt % titanium.

### Embodiment 6 Preparation of Liquid Titanium-Based Catalyst

731.2 g 1, 4-butanediol, 29.9 g TEOS, 30.7 g magnesium acetate, 298 g tetrabutyl titanate were added to a three-necked glass flask with a stirrer, dissolved in 1,600 g anhydrous ethanol solution, to react 1.9 hour under 160° C. to remove some small molecules; at this time, 99.3 g citric acid, 443.6 g triethyl phosphate were added successively to continue to react 1.9 hour under 160° C., then the byproduct was removed, to get liquid catalyst containing 4.22 wt % titanium.

### Embodiment 7 Preparation of Liquid Titanium-Based Catalyst

787.5 g 1, 4-butanediol, 33.8 g TEOS, 34.7 g magnesium acetate, 312 g tetrabutyl titanate were added to a three-necked glass flask with a stirrer, dissolved in 2,000 g anhydrous ethanol solution, to react 2.2 hours under 170° C. to remove some small molecules; at this time, 116.2 g citric acid, 477.7 g triethyl phosphate were added successively to continue to react 2.2 hours under 170° C., then the byproduct was removed, to get liquid catalyst containing 4.20 wt % titanium.

### Embodiment 8 Preparation of Liquid Titanium-Based Catalyst

843.7 g 1, 4-butanediol, 37.7 g TEOS, 38.7 g magnesium acetate, 326 g tetrabutyl titanate were added to a three-necked glass flask with a stirrer, dissolved in 2,300 g anhydrous ethanol solution, to react 2.5 hours under 190° C.; to remove some small molecules; at this time, 133.1 g citric acid, 511.8 g triethyl phosphate were added successively to continue to react 2.5 hours under 190° C., then the byproduct was removed, to get liquid catalyst containing 4.12 wt % titanium.

### Embodiment 9 Preparation of Liquid Titanium-Based Catalyst

900 g 1, 4-butanediol, 41.6 g TEOS, 42.8 g magnesium acetate, 340 g tetrabutyl titanate were added to a three-necked glass flask with a stirrer, dissolved in 2,700 g anhydrous ethanol solution, to react 3 hours under 200° C. to remove some small molecules; at this time, 133.1 g citric acid, 546 g triethyl phosphate were added successively to continue to react 3 hours under 200° C., then the byproduct was removed, to get liquid catalyst containing 4.12 wt % titanium.

### Embodiment 10 Preparation of Polyester Polymer with Liquid Titanium-Based Catalyst

100 kg succinic acid, 95 kg 1,4-butanediol and 10 kg adipic acid were added to a production reactor equipped with a mixer, a rectification tower, a condenser and a collecting tank to have an esterification reaction under the normal pressure condition; 2 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 255° C., 3 hours later, the reaction was stopped. The material in the reactor was discharged by pressurizing with nitrogen gas, and the polymer was cooled down, granulated by a granulator to get the polyester granules.

### Embodiment 11 Preparation of Polyester Polymer with Liquid Titanium-Based Catalyst

100 kg succinic acid, 99 kg 1,4-butanediol and 15 kg adipic acid were added to a production reactor equipped with a mixer, a rectification tower, a condenser and a collecting tank to have an esterification reaction under the normal pressure condition; 3 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 255° C., 4 hours later, the reaction was stopped. The material in the reactor was discharged by pressurizing with nitrogen gas, and the polymer was cooled down, granulated by a granulator to get the polyester granules.

### Embodiment 12 Preparation of Polyester Polymer with Liquid Titanium-Based Catalyst

100 kg succinic acid, 102.5 kg 1,4-butanediol and 20 kg adipic acid were added to a production reactor equipped with a mixer, a rectification tower, a condenser and a collecting tank to have an esterification reaction under the normal pressure condition; 4 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 255° C., 5 hours later, the reaction was stopped. The material in the reactor was discharged by pressurizing with nitrogen gas, and the polymer was cooled down, granulated by a granulator to get the polyester granules.

### Embodiment 13 Preparation of Polyester Polymer with Liquid Titanium-Based Catalyst

100 kg succinic acid, 106 kg 1,4-butanediol and 25 kg adipic acid were added to a production reactor equipped with a mixer, a rectification tower, a condenser and a collecting tank to have an esterification reaction under the normal pressure condition; 4 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 255° C., 6 hours later, the reaction was stopped. The material in the reactor was discharged by pressurizing with nitrogen gas, and the polymer was cooled down, granulated by a granulator to get the polyester granules.

### Embodiment 14 Preparation of Polyester Polymer with Liquid Titanium-Based Catalyst

100 kg succinic acid, 109 kg 1,4-butanediol and 30 kg adipic acid were added to a production reactor equipped with a mixer, a rectification tower, a condenser and a collecting tank to have an esterification reaction under the normal pressure condition; 4 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 255° C., 7 hours later, the reaction was stopped. The material in the reactor was discharged by pressurizing with nitrogen gas, and the polymer was cooled down, granulated by a granulator to get the polyester granules.

### Embodiment 15 Preparation of Polyester Polymer with Liquid Titanium-Based Catalyst

100 kg succinic acid, 99 kg 1,4-butanediol and 10 kg adipic acid were added to a production reactor equipped with a mixer, a rectification tower, a condenser and a collecting tank to have an esterification reaction under the normal pressure condition; 3 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 260° C., 6 hours later, the reaction was stopped. The material in the reactor was discharged by pressurizing with nitrogen gas, and the polymer was cooled down, granulated by a granulator to get the polyester granules.

### Embodiment 16 Preparation of Polyester Polymer with Liquid Titanium-Based Catalyst

100 kg succinic acid, 99 kg 1,4-butanediol and 10 kg adipic acid were added to a production reactor equipped with a mixer, a rectification tower, a condenser and a collecting tank to have an esterification reaction under the normal pressure condition; 4 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 245° C., 5 hours later, the reaction was stopped. The material in the reactor was discharged by pressurizing with nitrogen gas, and the polymer was cooled down, granulated by a granulator to get the polyester granules.

### Embodiment 17 Preparation of Polyester Polymer with Liquid Titanium-Based Catalyst

100 kg succinic acid, 99 kg 1,4-butanediol and 10 kg adipic acid were added to a production reactor equipped with a mixer, a rectification tower, a condenser and a collecting tank to have an esterification reaction under the normal pressure condition; 3 hours later, when the distillate reached the theoretical amount, it was considered as completion of esterification reaction. The material was conveyed to a polymerization reactor with nitrogen gas, and 2 kg of diluted liquid catalyst was added to stir 10 min, then the reactor was heated to increase the temperature of reactants and start the vacuum pump to gradually reduce the vacuum degree in the reactor for polymerization reaction, and then the vacuum degree was reduced to 1 mmHg or less, and temperature was increased to 240° C., 5 hours later, the reaction was stopped. The material in the reactor was discharged by pressurizing with nitrogen gas, and the polymer was cooled down, granulated by a granulator to get the polyester granules.

A tensile test was conducted for the polyester polymers obtained in above embodiments, and results were as follows:

TABLE 1
Temperature: 25° C. Speed: 50 mm/min
Given stress: 0 Mpa Given elongation rate: 100%

| | | Elastic | | | |
|---|---|---|---|---|---|
| | Tensile | modu- | Yield | Elonga- | Breaking |
| | strength | lus | strength | tion at | strength |
| | (MPa) | (GPa) | (MPa) | break (%) | (MPa) |
| Embodiment 10 | 30.2571 | 0.2562 | 22.6857 | 410.7766 | 23.5857 |
| Embodiment 11 | 30.4714 | 0.2317 | 21.6571 | 441.1876 | 18.8571 |
| Embodiment 12 | 30.3429 | 0.2643 | 22.4429 | 407.3400 | 29.4143 |

TABLE 2
Temperature: 25° C. Speed: 50 mm/min
Given stress: 0 Mpa Given elongation rate: 100%

| | | Elastic | | | |
|---|---|---|---|---|---|
| | Tensile | modu- | Yield | Elonga- | Breaking |
| | strength | lus | strength | tion at | strength |
| | (MPa) | (GPa) | (MPa) | break (%) | (MPa) |
| Embodiment 12 | 27.8286 | 0.1875 | 19.1714 | 511.9308 | 19.2618 |
| Embodiment 13 | 27.9136 | 0.1927 | 20.1327 | 513.2704 | 20.2581 |
| Embodiment 14 | 27.9475 | 0.2034 | 22.3634 | 515.3629 | 21.3720 |

TABLE 3
Temperature: 25° C. Speed: 50 mm/min
Given stress: 0 Mpa Given elongation rate: 100%

| | | Elastic | | | |
|---|---|---|---|---|---|
| | Tensile | modu- | Yield | Elonga- | Breaking |
| | strength | lus | strength | tion at | strength |
| | (MPa) | (GPa) | (MPa) | break (%) | (MPa) |
| Embodiment 15 | 33.1429 | 0.3291 | 33.1429 | 318.1168 | 27.6000 |
| Embodiment 16 | 32.8714 | 0.2898 | 32.8714 | 312.8646 | 28.4143 |
| Embodiment 17 | 32.3429 | 0.3027 | 32.3429 | 314.8098 | 23.9143 |

The basic principles and main features and advantages of the inventions are described herein. Technicians skilled in the art should be aware that, the invention is not limited to the above embodiments and above embodiments and descriptions are only for explanations of the principles for the invention. Variation and modifications can be made without departing from the spirit and scope of the invention, and all these variations and modifications must be within the scope of protection as claimed in the invention. The scope of protection of the invention is defined by the appended claims and equivalents thereof.

1: A liquid titanium-based catalyst comprising the following compositions (in mass ratio):
1,4 butanediol 450-900 portions
TEOS and/or n-methyl silicate and/or n-propyl silicate 10.4-41.6 portions
Acetates or aluminum nitrate 10.7-42.8 portions
Tetrabutyl titanate and/or tetraethyl titanate and/or tetraisopropyl titanate 228-340 portions
Solvent 92-2700 portions
Hydroxycarboxylic acid 15-150 portions
Phosphate ester 273-546 portions

2: The liquid titanium-based catalyst according to claim 1, wherein the solvents are one or more of anhydrous ethanol, cyclohexane, toluene, mixed xylene.

3: The liquid titanium-based catalyst according to claim 1, wherein the acetates are selected from one or more of acetates of IA, IIA, IIIA, IIB, IIIB, VIIB, VIIIB metal elements.

4: The liquid titanium-based catalyst according to claim 1, wherein the hydroxycarboxylic acids are one or more of citric acid, L-lactic acid, tartaric acid, salicylic acid.

5: The method liquid titanium-based catalyst according to claim 1, wherein the phosphate esters are one or more of trimethyl phosphate, triethyl phosphate, trimethyl phosphite, triethyl phosphite, triphenyl phosphate.

6: The method for preparing liquid titanium-based catalyst according to any one of claims 1-5, comprising the following steps:
a) adding 1,4-butanediol, TEOS and/or n-methyl silicate and/or n-propyl silicate, acetates or aluminum nitrate, tetrabutyl titanate and/or tetraethyl titanate and/or tetraisopropyl titanate to a three-necked glass flask with a stirrer, dissolved in the solvent, and reacting 0.5˜3 h at the temperature of 80˜200° C.;
b) then adding hydroxycarboxylic acid, phosphate eater to continue to react 0.5˜3 h at the temperature of 80˜200° C., to obtain titanium-containing liquid catalyst.

7: The method for preparing liquid titanium-based catalyst according to claim 6 is used for preparing polyester polymer.

8: The liquid titanium tie preparation method of catalysts used in polyester polymer according to claim 7, comprising the following steps:
1) adding 100 portions of succinic acid, 95-109 portions of 1-4 butenediol, 10-20 portions of adipic acid, to a reactor, to have an esterification reaction under the normal pressure condition for 2-5 h to get the material;
2) then conveying the material to a polymerization reactor with nitrogen gas, adding 2 portions of diluted liquid titanium-based catalyst to stir 10 min, and gradually heating the reactor to increase the temperature of reactants and start the vacuum pump to gradually reduce the vacuum degree in the reactor for polymerization reaction, then reducing the vacuum degree to 1 mm Hg or less, and increasing the temperature to 240˜260° C., 3-8 hours later, stopping the reaction;
3) discharging the material in the reactor by pressurizing with nitrogen gas, and cooling down the polymer, granulating by a granulator to get the polyester granules.
